(19) United States
(12) Patent Application Publication
(10) Pub. No.: US 2020/0254735 A1
(43) Pub. Date: Aug. 13, 2020

(54) MULTILAYER FILMS SUITABLE FOR USE IN THERMOFORMING APPLICATIONS

(71) Applicant: Dow Global Technologies LLC, Midland, MI (US)

(72) Inventors: Arnaldo Lorenzo, Freeport, TX (US); João Gargalaka, Jr., São Paulo (BR); Fanny Deplace, Freeport, TX (US); Jorge C. Gomes, Sao Paulo (BR); Mridula Kapur, Lake Jackson, TX (US); Kumar N. Sanketh, Freeport, TX (US)

(21) Appl. No.: 15/774,521

(22) PCT Filed: Dec. 13, 2016
(86) PCT No.: PCT/US2016/066254

§ 371 Date: May 8, 2018

Related U.S. Application Data
(60) Provisional application No. 62/269,194, filed on Dec. 18, 2015.

(51) Int. Cl. B32B 27/08; B32B 27/32; B65D 65/40

(52) U.S. Cl. CPC B32B 27/08; B32B 27/327; B32B 27/325; B65D 65/40; B32B 2250/242; B32B 2553/00; B32B 2250/05; B32B 2307/7246; B32B 2307/7244; B32B 2250/40; B32B 2307/738; B32B 2270/00

(57) ABSTRACT

The present invention provides multilayer films. In some embodiments, multilayer films of the present invention are desirable for use in thermoforming applications. In one aspect, a multilayer film comprises a first layer comprising polypropylene, polyethylene, or blends thereof, a second layer comprising polypropylene, polyethylene, or blends thereof, and a third layer between the first layer and the second layer, the third layer comprising polypropylene, polyethylene, or blends thereof, wherein at least one of the layers further comprises a cyclic olefin copolymer and wherein the multilayer film comprises at least 1 weight percent and less than 5 weight percent cyclic olefin copolymer based on the total weight of the film.

### FIELD

The present invention relates to multilayer films and in particular, multilayer films suitable for use in thermoforming applications.

### INTRODUCTION

Thermoforming is one of the most frequently used thermoplastic film-forming techniques in packaging applications because of ease of production, low cost, high speed, and high performance. There are generally two types of thermoformed packaging: rigid and flexible. For rigid thermoforming sheets, the main materials typically used are polystyrene (PS), polyester (including polyethylene terephthalate (PET)), and polypropylene (PP). For flexible thermoformed packaging, coextrusion is usually used due to the complexity of the structure resulting from the presence of polyamide (PA) or polypropylene (PP) layers which are generally considered to be indispensable due to their good thermo-mechanical properties that allow good thermoformability.

Quality problems related to thermoforming can be linked directly with the structural composition of the films. Polymers must generally be chosen which will support the thermoforming process. Frequent problems which have been reported are: high thickness variation of the thermoformed film (wall thickness distribution) (see, for example, Ayhan, Z.a.Z., H., “Wall Thickness Distribution in Thermoformed Food Containers Produced by a Benco Aseptic Packaging Machine”, Polymer Engineering and Science, 2000, 40); rupture of the film after the thermoforming (see, for example, N. J. Macauley, E.M.A.H.-1., and W. R. Murphy, “The Influence of Extrusion Parameters on the Mechanical Properties of Polypropylene Sheet”, Polymer Engineering and Science, 1998, 38); and irregularities in the surface of the thermoformed film.

There remains a need for new multilayer films having properties desirable for use in thermoforming applications.

### SUMMARY

The present invention provides multilayer films that in some aspects deliver a combination of properties suitable for thermoforming and other applications. For example, in some embodiments, multilayer films of the present invention provide improved mechanical stiffness when thermoformed into articles. In some embodiments, multilayer films of the present invention can exhibit desirable moisture and/or oxygen barrier properties. Other advantages exhibited by some embodiments of the present invention can include improved toughness, improved puncture resistance, downgauging potential, and/or reduced cost compared to other options. For example, a multilayer film formed primarily from polyethylene with one or more desirable properties, according to some embodiments, can offer cost savings as compared to multilayer films having one or more polyamide layers.

In one aspect, the present invention provides a multilayer film that comprises a first layer comprising polypropylene, polyethylene, or blends thereof, a second layer comprising polypropylene, polyethylene, or blends thereof, and a third layer between the first layer and the second layer, the third layer comprising polypropylene, polyethylene, or blends thereof, wherein at least one of the layers further comprises a cyclic olefin copolymer and wherein the multilayer film comprises at least 1 weight percent and less than 5 weight percent cyclic olefin copolymer based on the total weight of the film.

In another aspect, the present invention provides multilayer film that comprises a first layer comprising polyethylene, a second layer comprising polyethylene, and a third layer between the first layer and the second layer, the third layer comprising polyethylene, wherein at least one of the layers further comprises a cyclic olefin copolymer and wherein the multilayer film comprises at least 1 weight percent and less than 5 weight percent cyclic olefin copolymer based on the total weight of the film.

These and other embodiments are described in more detail in the Detailed Description.

### BRIEF DESCRIPTION OF DRAWINGS

FIG. 1 is a graph illustrating a portion of the elastic modulus (E′) data in the Example.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount of ethylene monomer (based on the weight of the interpolymer), and an α-olefin.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising greater than 50% by weight of units which have been derived from ethylene monomer. This includes ethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.935 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, single-site catalysts including, but not limited to, bis-metallocene catalysts and constrained geometry catalysts, and post-metallocene, molecular catalysts.

“Polypropylene” or “propylene-based polymer” refers to polymers comprising greater than 50% by weight of units which have been derived from propylene monomer. This includes propylene homopolymer, random copolymer polypropylene, impact copolymer polypropylene, propylene/α-olefin interpolymer, and propylene/α-olefin copolymer. These polypropylene materials are generally known in the art. “Polypropylene” also includes the relatively newer class of polymers known as propylene based plastomers or elastomers (“PBE” or “PBPE”). These propylene/alpha-olefin copolymers are further described in detail in U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

The term, “propylene/α-olefin interpolymer,” as used herein, refers to an interpolymer that comprises, in polymerized form, a majority amount of propylene monomer (based on the weight of the interpolymer), and an α-olefin.

The term, “propylene/α-olefin copolymer,” as used herein, refers to a copolymer that comprises, in polymerized form, a majority amount of ethylene monomer (based on the weight of the copolymer), and an α-olefin, as the only two monomer types.

Unless otherwise indicated herein, the following analytical methods are used in the describing aspects of the present invention:

“Density” is determined in accordance with ASTM D792.

“Melt index”: Melt indices I₂ (or I2) and I₁₀ (or I10) are measured in accordance with ASTM D-1238 at 190° C. and at 2.16 kg and 10 kg load, respectively. Their values are reported in g/10 min. “Melt flow rate” is used for polypropylene based resins and determined according to ASTM D1238 (230° C. at 2.16 kg).

“Secant Modulus (1%)”, “Secant Modulus (2%)”, and “Secant Modulus (10%)” are determined in accordance with ASTM D882.

“Water Vapor Transmission Rate” or “WVTR” is determined in accordance with ASTM F-1249 using a Mocon Permatran WVTR testing system (Model 3/33) at a relative humidity of 100% and a temperature of 37.8° C.

“Oxygen Transmission Rate” or “OTR” is determined in accordance with ASTM D3985 using a Mocon Oxtran OTR testing system (Model 2/21) at an oxygen content of 100%, a relative humidity of 90%, and a temperature of 23° C.

“Puncture Resistance” is determined according to ASTM D5748, at a chamber temperature of 100° C.

Additional properties and test methods are described further herein.

In one aspect, the present invention provides a multilayer film that comprises a first layer comprising polypropylene, polyethylene, or blends thereof, a second layer comprising polypropylene, polyethylene, or blends thereof, and a third layer between the first layer and the second layer, the third layer comprising polypropylene, polyethylene, or blends thereof, wherein at least one of the layers further comprises a cyclic olefin copolymer and wherein the multilayer film comprises at least 1 weight percent and less than 5 weight percent cyclic olefin copolymer based on the total weight of the film.

In another aspect, the present invention provides multilayer film that comprises a first layer comprising polyethylene, a second layer comprising polyethylene, and a third layer between the first layer and the second layer, the third layer comprising polyethylene, wherein at least one of the layers further comprises a cyclic olefin copolymer and wherein the multilayer film comprises at least 1 weight percent and less than 5 weight percent cyclic olefin copolymer based on the total weight of the film.

In some embodiments, the cyclic olefin copolymer comprises a norbomene ethylene copolymer. In some embodiments wherein the first layer, second layer and/or third layer comprise polypropylene, the polypropylene comprises propylene/α-olefin copolymer, propylene homopolymer, or blends thereof.

In some embodiments, at least two layers of the multilayer film comprise cyclic olefin copolymer. For example, in some embodiments, the first and second layers further comprise cyclic olefin copolymer. In some embodiments, the first layer comprises 5 to 15 weight percent cyclic olefin copolymer based on the weight of the first layer, and the second layer comprises 5 to 15 weight percent cyclic olefin copolymer based on the weight of the second polymer.

In some embodiments, the third layer further comprises cyclic olefin copolymer. In a further embodiment, at least one additional layer also comprises cyclic olefin copolymer.

In some embodiments, a multilayer film of the present invention exhibits a water vapor transmission rate (WVTR) of 1.10 g·mil/m²/day or less when measured according to ASTM F1249 at a relative humidity of 100% and a temperature of 37.8° C. A multilayer film of the present invention exhibits a WVTR of 1.05 g·mil/m²/day or less when measured according to ASTM F1249 at a relative humidity of 100% and a temperature of 37.8° C. in some embodiments. In some embodiments, a multilayer film of the present invention exhibits a WVTR of 1.00 g·mil/m²/day or less when measured according to ASTM F1249 at a relative humidity of 100% and a temperature of 37.8° C.

In some embodiments, a multilayer film of the present invention exhibits an oxygen transmission rate (OTR) of 820 cm³·mil/100 in²/day or less when measured in accordance with ASTM D3985 using a Mocon Oxtran OTR testing system (Model 2/21) at an oxygen content of 100%, a relative humidity of 90%, and a temperature of 23° C. A multilayer film of the present invention exhibits an OTR of 750 cm³·mil/100 in²/day or less in some embodiments. In some embodiments, a multilayer film of the present invention exhibits an OTR of 700 cm³·mil/100 in²/day or less.

In some embodiments, a multilayer film of the present invention exhibits a ratio of elastic modulus at 80° C. to elastic modulus at 100° C. of less than 10. The multilayer film exhibits a ratio of elastic modulus at 80° C. to elastic modulus at 100° C. of less than 8, in some embodiments. The multilayer film, in some embodiments, exhibits a ratio of elastic modulus at 80° C. to elastic modulus at 100° C. of less than 6.

In some embodiments, the multilayer film comprises up to 11 layers. The multilayer film comprises at least 5 layers in some embodiments. In some embodiments, the two outermost layers comprise cyclic olefin copolymer. For example, in some embodiments where the film comprises 5 to 11 layers, the two outermost layers can comprise cyclic olefin copolymer. In some embodiments, at least one layer of the multilayer film comprises ethylene vinyl alcohol. The multilayer film, in some embodiments, is free of polyamide.

The multilayer film, in some embodiments, has a thickness of 10 to 250 microns (μm). In some embodiments, the multilayer film is a coextruded film.

A multilayer film of the present invention can comprise a combination of two or more embodiments as described herein.

Embodiments of the present invention also relate to articles formed from any of the multilayer films of the present invention disclosed herein.

### Layer Components

As set forth herein, a multilayer film of the present invention comprises at least 3 layers. In some embodiments, a multilayer film of the present invention comprises up to 11 layers. The number of layers can depend on a number of factors including the intended application (e.g., article or use) for the film, the desired thickness of the film, whether the film incorporates one or more barrier layers, and others. In some embodiments, the multilayer film comprises from 3 to 11 layers. All individual values and subranges from 3 to 11 layers are included herein and disclosed herein. For example, the multilayer film can have 3, 4, 5, 6, 7, 8, 9, 10, or 11 layers in various embodiments.

In some embodiments, one or more layers can comprise polypropylene, polyethylene, or blends thereof. Such layers can comprise any polypropylene or polyethylene known to those of skill in the art to be suitable for use as a layer in a multilayer film based on the teachings herein.

In some embodiments where one or more layers comprise polypropylene, the polypropylene can comprise propylene/α-olefin copolymer, propylene homopolymer, or blends thereof. The propylene/α-olefin copolymer, in various embodiments, can be random copolymer polypropylene (rcPP), impact copolymer polypropylene (hPP+at least one elastomeric impact modifier) (ICPP), high impact polypropylene (HIPP), high melt strength polypropylene (HMS-PP), isotactic polypropylene (iPP), syndiotactic polypropylene (sPP), propylene based copolymers with ethylene (e.g., VERSIFY™ plastomers and elastomers which are commercially available from The Dow Chemical Company), and combinations thereof. Examples of polypropylenes that can be used in embodiments of the present invention are commercially available from Braskem S.A.

The polyethylene that can be used in one or more layers of the multilayer film can be ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), homogeneously-branched ethylene/α-olefin copolymers made with a single site catalyst such as a metallocene catalyst or a constrained geometry catalyst, and combinations thereof. In some embodiments, the one or more polyethylenes have a density greater than 0.920 g/cm³ or less. Examples of polyethylenes that can be used in some embodiments of the present invention include, without limitation, DOW™ low density polyethylenes (LDPE) and linear low density polyethylenes (LLDPE), DOWLEX™ linear low density polyethylenes (LLDPE), ATTANE™ ultra low density polyethylenes (ULDPE), ELITE™ enhanced polyethylenes, each being commercially available from The Dow Chemical Company, and others.

In some embodiments, a multilayer film of the present invention can comprise one or more barrier layers. In such embodiments, the barrier layer may comprise one or more polyamides (nylons) and/or ethylene vinyl alcohol copolymers (EVOH). EVOH can include a vinyl alcohol copolymer having 27 to 44 mol % ethylene, and is prepared by, for example, hydrolysis of vinyl acetate copolymers. Examples of commercially available EVOH that can be used in embodiments of the present invention include EVAL™ from Kuraray and Noltex™ from Nippon Goshei.

In embodiments where the barrier layer comprises polyamide, the polyamide can include polyamide 6, polyamide 9, polyamide 10, polyamide 11, polyamide 12, polyamide 6,6, polyamide 6/66 and aromatic polyamide such as polyamide 6I, polyamide 6T, MXD6, or combinations thereof.

One advantage of some embodiments of the present invention is that in some embodiments intended for use in thermoforming applications, the multilayer films can be free of polyamide. In some such embodiments, the absence of polyamide can result in a less expensive multilayer film with thermoforming properties comparable to multilayer films comprising polyamide. In some embodiments, a multilayer film can comprise less than 5 weight percent polyamide, or less than 3 weight percent polyamide, or less than 1 weight percent polyamide, or less than 0.5 weight percent polyamide, each based on the total weight of the film. However, as indicated above, there are some embodiments (e.g., when polyamide is to be used as a barrier layer), where a multilayer film includes larger amounts of polyamide.

In some embodiments, multilayer films of the present invention can include a tie layer. A tie layer may be used to adhere two layers together during coextrusion particularly where there is an incompatibility between the compositions of the two layers. For example, if a multilayer film comprises an ethylene vinyl alcohol barrier layer, a tie layer may be used to adhere the ethylene vinyl alcohol layer to a layer comprising predominantly polyolefins. Persons of skill in the art can determine whether a tie layer is needed and if so, select an appropriate tie layer, depending on the composition of the layers to be included in the multilayer film based on the teachings herein.

It should be understood that any of the layers within a multilayer film of the present invention can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

### Cyclic Olefin Copolymer

Embodiments of the present invention advantageously incorporate cyclic olefin copolymer into one or more layers of the multilayer film (in addition to one or more of the components described above). The cyclic olefin copolymer can be blended with the one or more other components to form a layer within the film using techniques known to those of skill in the art based on the teachings herein.

Cyclic olefin copolymers are produced by chain copolymerization of cyclic monomers, such as 8,9,10-trinorbom-2-ene (norbomene) or 1,2,3,4,4a,5,8,8a-octahydro-1,4:5,8-dimethanonaphthalene (tetracyclododecene), with ethylene. In some embodiments, the cyclic olefin copolymer comprises a norbomene ethylene copolymer. Examples of cyclic olefin copolymers include those available under the name TOPAS from TOPAS Advanced Polymers, Inc. (Florence, Ky., USA) and the name APEL from Mitsui Chemicals America, Inc. (Rye Brook, NY, USA). As used herein, cyclic olefin copolymers also include those compounds made by ring-opening metathesis polymerization of various cyclic monomers followed by hydrogenation, such as those available under the name ARTON from JSR Corp. (Minato-ku, Tokyo, Japan) and under the names ZEONEX and ZEONOR from ZEON Chemicals L.P. (Louisville, Ky., USA).

The inclusion of relatively low amounts of cyclic olefin copolymer (e.g., less than 5 weight percent based on the total weight of the multilayer film) as well as the distribution of the cyclic olefin copolymer within the multilayer film has been discovered, in some embodiments, to impart greater modulus and/or stiffness to facilitate the film's usage in thermoformed packaging. For example, the advantages of incorporating the cyclic olefin copolymer into the blends used in one or more layers of the film can include excellent thermoformability, improved toughness, improved puncture resistance, potential for downgauging, and/or lower cost (e.g., when compared to thermoformable films having a polyamide layer).

In embodiments of the present invention, the multilayer film comprises at least 1 weight percent and less than 5 weight percent of the cyclic olefin copolymer based on the total weight of the film. All individual values and subranges from 1 to less than 5 wt % are included and disclosed herein; for example, the amount of the cyclic olefin copolymer can range from a lower limit of 1.0, 1.5, 2.0, 2.5, 3.0, 3.5, 4.0 wt % to an upper limit of 2.0, 2.5, 3.0, 3.5, 4.0, 4.5, or 4.9 wt %, based on the total weight of the film. For example, the amount of the cyclic olefin copolymer is from 1.0 to less than 5.0 wt %, or in the alternative, from 1 to 4.5 wt %, or in the alternative, from 1.5 to 4.5 wt %, or in the alternative, from 2.0 to 4.0 wt %, or in the alternative, from 3.0 to 4.0 wt % based on the total weight of the film.

In some embodiments, the cyclic olefin copolymer is blended with a polyolefin in only a single layer of the multilayer film. For example, in some embodiments, the cyclic olefin polymer is incorporated in an inner layer of the multilayer film (e.g., one of the 3 inner layers in a 5 layer film). In some embodiments, the cyclic olefin polymer is incorporated in a core layer of the multilayer film (e.g., layer B in a 3 layer (A/B/C) film, or layer C in a 5 layer (A/B/C/D/E) film, etc.).

In some embodiments, it is preferable to include the cyclic olefin copolymer in at least two layers, with the total amount of cyclic olefin copolymer in the multilayer film being less than 5 weight percent. In some embodiments, the cyclic olefin copolymer can be incorporated in the two outermost layers (e.g., skin layers) of a multilayer film. In some embodiments, the cyclic olefin copolymer can be incorporated in two or more interior layers. For example, in a 5 layer film (A/B/C/D/E), cyclic olefin copolymer can be incorporated in layers A and E in some embodiments, in layers B and D in some embodiments, in layers B/C/D in some embodiments, in layers A/C/E in some embodiments, etc. When the cyclic olefin copolymer is incorporated into two or more layers, such layers can include generally equal amounts of cyclic olefin copolymer.

### Multilayer Films

Multilayer films of the present invention preferably have a total thickness (before thermoforming) in the range of from 10 μm to 250 μm, preferably 50 μm to 200 μm, or 100 μm to 180 μm. Individual layer thickness can vary depending on the number of layers available, the type of layer (e.g., skin layer, barrier layer, inner layer, etc.) and the total thickness of the film.

Multilayer films of the present invention can be coextruded (e.g., using a blown film process or a cast film process) in some embodiments using techniques known to those of skill in the art.

Multilayer films of the present invention are well-suited for use in thermoforming applications in some embodiments.

### Articles

Multilayer films can be formed into a variety of articles using techniques known to those of skill in the art. For example, multilayer films of the present invention can be thermoformed into an article in some embodiments. Examples of such articles include rigid containers, flexible trays, and semi-flexible packaging. Such articles can be used, for example, in the packaging of foods such as fruit, cheese, meat, processed meat, processed food, and frozen food.

Multilayer films of the present invention can be thermoformed using techniques known to those of skill in the art based on the teachings herein. For example, multilayer films can be thermoformed into trays having a depth of 50 to 150 mm using a Multivac R530 Thermoformer at a temperature of 80° C. to 120° C., for a heating time of 1.0-1.5 seconds, and a forming time of 1.0-1.5 seconds.

Some embodiments of the invention will now be described in detail in the following Examples.

### Examples

The following materials are used in the examples discussed below:

| | | Melt Index (I₂) | |
|---|---|---|---|
| Product | Abbreviation | (dg/min) | Density (g/cm³) |
| ELITE ™ 5401GS | PE | 1.0 | 0.918 |
| TOPAS 6013F-04 | COC | — | — |

ELITE™ 5401GS is an enhanced polyethylene, which is commercially available from The Dow Chemical Company. TOPAS 6013F-04 is a cyclic olefin copolymer copolymerized from norbornene and ethylene using a metallocene catalyst commercially available from TOPAS Advanced Polymers. According to the technical data sheet from TOPAS, TOPAS 6013F-04 has a density (per ISO 1133) of 1020 kg/m³ and a melt volume rate (MVR) at 230° C. and 2.16 kg of 1.0 cm³/10 minutes.

A number of five layer films are coextruded in an A/B/C/D/E structure as shown in Table 1:

TABLE 1

| | | Weight % COC |
|---|---|---|
| | A/B/C/D/E | (based on total |
| | (percentages are weight %) | weight of film) |
| Inventive | Layer A: 100% PE | 4% COC |
| Example 1 | Layer B: 100% PE | |
| | Layer C: 80% PE; 20% COC | |
| | Layer D: 100% PE | |
| | Layer E: 100% PE | |
| Inventive | Layer A: 100% PE | 4% COC |
| Example 2 | Layer B: 90% PE; 10% COC | |
| | Layer C: 100% | |
| | Layer D: 90% PE; 10% COC | |
| | Layer E: 100% PE | |
| Inventive | Layer A: 90% PE; 10% COC | 4% COC |
| Example 3 | Layer B: 100% PE | |
| | Layer C: 100% PE | |
| | Layer D: 100% PE | |
| | Layer E: 90% PE; 10% COC | |
| Inventive | Layer A: 100% PE | 2% COC |
| Example 4 | Layer B: 95% PE; 5% COC | |
| | Layer C: 100% PE | |
| | Layer D: 95% PE; 5% COC | |
| | Layer E: 100% PE | |
| Inventive | Layer A: 95% PE; 5% COC | 2% COC |
| Example 5 | Layer B: 100% PE | |
| | Layer C: 100% PE | |
| | Layer D: 100% PE | |
| | Layer E: 95% PE; 5% COC | |
| Inventive | Layer A: 80% PE; 20% COC | 4% COC |
| Example 6 | Layer B: 100% PE | |
| | Layer C: 100% PE | |
| | Layer D: 100% PE | |
| | Layer E: 100% PE | |

Each of the above films are fabricated on a Collin coextrusion blown film line (Model BL 180/400 from Dr. Collin GMBH) under the conditions shown in Table 2 to form the 5 layer multilayer film (A/B/C/D/E):

TABLE 2

| Parameter Name | Unit | Range |
|---|---|---|
| Layer ratio - Layer A | % | 20 |
| Layer ratio - Layer B | % | 20 |
| Layer ratio - Layer C | % | 20 |
| Layer ratio - Layer D | % | 20 |
| Layer ratio - Layer E | % | 20 |
| Total Thickness | μm | 150 |
| Air Temperature | ° C. | 15 |
| Layflat | mm | 314 |
| Blow Up Ratio (B.U.R.) | | 2.5 |
| Die gap | mm | 1.8 |
| Blower | % | 58 |
| Takeoff | m/min | 3.8 |
| Structure | | A/B/C/D/E |
| Total Output | kg/h | 20.32 |
| Die Temperature | ° C. | 225 |
| Temperature-Zone 02 - Extruder A (External) | ° C. | 190 |
| Temperature-Zone 03 - Extruder A (External) | ° C. | 205 |
| Temperature-Zone 04 - Extruder A (External) | ° C. | 210 |
| Temperature-Zone 05 - Extruder A (External) | ° C. | 220 |
| Temperature-Zone 06 - Extruder A (External) | ° C. | 220 |
| Temperature-Zone 07 - Extruder A (External) | ° C. | 220 |
| RPM - Extruder A (External) | rpm | 52 |
| Amps - Extruder A (External) | A | 5.6 |
| Melt temperature - Extruder A (External) | ° C. | 202 |
| Melt pressure - Extruder A (External) | bar | 289 |
| Output - Extruder A (External) | kg/h | 3.98 |
| Temperature-Zone 02 - Extruder B | ° C. | 190 |
| Temperature-Zone 03 - Extruder B | ° C. | 205 |
| Temperature-Zone 04 - Extruder B | ° C. | 210 |
| Temperature-Zone 05 - Extruder B | ° C. | 220 |
| Temperature-Zone 06 - Extruder B | ° C. | 220 |
| Temperature-Zone 07 - Extruder B | ° C. | 220 |
| RPM - Extruder B | rpm | 96 |
| Amps - Extruder B | A | 4.2 |
| Melt temperature - Extruder B | ° C. | 209 |
| Melt pressure - Extruder B | bar | 332 |
| Output - Extruder B | kg/h | 4.06 |
| Temperature-Zone 02 - Extruder C | ° C. | 190 |
| Temperature-Zone 03 - Extruder C | ° C. | 205 |
| Temperature-Zone 04 - Extruder C | ° C. | 210 |
| Temperature-Zone 05 - Extruder C | ° C. | 220 |
| Temperature-Zone 06 - Extruder C | ° C. | 220 |
| Temperature-Zone 07 - Extruder C | ° C. | 220 |
| RPM - Extruder C | rpm | 96 |
| Amps - Extruder C | A | 3.9 |
| Melt temperature - Extruder C | ° C. | 215 |
| Melt pressure - Extruder C | bar | 304 |
| Output - Extruder C | kg/h | 4.22 |
| Temperature-Zone 02 - Extruder D | ° C. | 190 |
| Temperature-Zone 03 - Extruder D | ° C. | 205 |
| Temperature-Zone 04 - Extruder D | ° C. | 210 |
| Temperature-Zone 05 - Extruder D | ° C. | 220 |
| Temperature-Zone 06 - Extruder D | ° C. | 220 |
| Temperature-Zone 07 - Extruder D | ° C. | 220 |
| RPM - Extruder D | rpm | 96 |
| Amps - Extruder D | A | 4 |
| Melt temperature - Extruder D | ° C. | 209 |
| Melt pressure - Extruder D | bar | 341 |
| Output - Extruder D | kg/h | 4.09 |
| Temperature-Zone 02 - Extruder E (Internal) | ° C. | 190 |
| Temperature-Zone 03 - Extruder E (Internal) | ° C. | 205 |
| Temperature-Zone 04 - Extruder E (Internal) | ° C. | 210 |
| Temperature-Zone 05 - Extruder E (Internal) | ° C. | 220 |
| Temperature-Zone 06 - Extruder E (Internal) | ° C. | 220 |
| Temperature-Zone 07 - Extruder E (Internal) | ° C. | 220 |
| RPM - Extruder E (Internal) | rpm | 55 |
| Amps - Extruder E (Internal) | A | 5.5 |
| Melt temperature - Extruder E (Internal) | ° C. | 212 |
| Melt pressure - Extruder E (Internal) | bar | 346 |
| Output - Extruder E (Internal) | kg/h | 3.91 |

The use of “(External)” in connection with Extruder A indicates that these properties are associated with Layer A, which is the outermost layer of the multilayer film when blown. The use of “(Internal)” in connection with Extruder E indicates that these properties are associated with Layer E, which is the innermost layer of the multilayer film when blown.

Comparative Examples are also prepared. Comparative Example A is constructed entirely from enhanced polyethylene (ELITE™ 5401GS) with no cyclic olefin copolymer. Comparative Example A is a 5 layer film fabricated under the same conditions as the Inventive Examples as specified in Table 2 above. Comparative Example B is a five layer film fabricated under the same conditions as the Inventive Examples as specified in Table 2 above with the following structure: Layer A: 100% PE (ELITE™ 5401GS); Layer B: 100% PE (ELITE™ 5401GS); Layer C: 100% polyamide; Layer D: 100% PE (ELITE™ 5401GS); Layer E 100% PE (ELITE™ 5401GS). A conventional tie layer is used to adhere the polyamide layer to the adjacent PE layers.

The average secant modulus (1%) is measured for each of the films in accordance with ASTM D882, and the results are shown in Table 3:

TABLE 3

| | | | Secant |
|---|---|---|---|
| | | Weight | Modulus |
| | Film Summary | % COC | (1%) (MPa) |
| Inventive Example 1 | 20% COC in Layer C | 4% | 470 |
| Inventive Example 2 | 10% COC in Layers B and | 4% | 458 |
| | D | | |
| Inventive Example 3 | 10% COC in Layers A and | 4% | 417 |
| | E | | |
| Inventive Example 4 | 5% COC in Layers B and D | 2% | 372 |
| Inventive Example 5 | 5% COC in Layers A and E | 2% | 368 |
| Inventive Example 6 | 20% COC in Layer A | 4% | 417 |
| Comparative | All PE (no COC) | 0% | 320 |
| Example A | | | |
| Comparative | 20% Polyamide | 0% | 444 |
| Example B | | | |

As shown above, the stiffness of the multilayer films increases as a function of the total COC loading in the multilayer film. Further, including COC in one or more layers of the film is an effective way to improve stiffness in comparison with the polyethylene-only multilayer film (Comparative Example A). Higher film stiffness, as characterized by higher modulus, offers the potential to downgauge the multilayer film and thus reduce cost. The data also show that adding 2-4 wt. % COC in the multilayer film will assist in reaching an acceptable stiffness target value (˜400 MPa) and provide a stiffness comparable to that of a film based on polyamide (Comparative Example B).

The water vapor transmission rates (WVTR) of the multilayer films are measured in accordance with ASTM F-1249 using a Mocon Permatran WVTR testing system (Model 3/33) at a relative humidity of 100% and a temperature of 37.8° C. The oxygen transmission rates (OTR) are measured in accordance with ASTM D3985 using a Mocon Oxtran OTR testing system (Model 2/21) at an oxygen content of 100%, a relative humidity of 90%, and a temperature of 23° C. These properties are measured on a six inch by six inch sample of the films. At least three measurements of each example film are made and the average values are shown in Table 4:

TABLE 4

| | | | WVTR | OTR |
|---|---|---|---|---|
| | | Weight % | (g*mil/100 | (cm³*mil/100 |
| | Film Summary | COC | in²/day) | in²/day) |
| Inventive | 20% COC in | 4% | 0.97 | 748 |
| Example 1 | Layer C | | | |
| Inventive | 10% COC in | 4% | 0.99 | 752 |
| Example 2 | Layers B | | | |
| | and D | | | |
| Inventive | 10% COC in | 4% | 0.99 | 673 |
| Example 3 | Layers A | | | |
| | and E | | | |
| Inventive | 5% COC in | 2% | 1.04 | 665 |
| Example 4 | Layers B | | | |
| | and D | | | |
| Inventive | 5% COC in | 2% | 1.05 | 732 |
| Example 5 | Layers A | | | |
| | and E | | | |
| Inventive | 20% COC in | 4% | 1.03 | 733 |
| Example 6 | Layer A | | | |
| Comparative | All PE (no | 0% | 1.10 | 824 |
| Example A | COC) | | | |
| Comparative | 20% | 0% | 1.19 | 40 |
| Example B | Polyamide | | | |

The data in Table 4 show an improvement in WVTR when 4 weight percent COC is used in the multilayer film structure. The improvement is roughly 10% over Comparative Example A (all PE) and 20% over Comparative Example B (polyamide based). For context, the standard deviation for this measurement method is less than 2%. Improved values are also seen for OTR for most of the Inventive Examples when compared to Comparative Example A (all PE), but not Comparative Example B which includes a polyamide layer and provides a high oxygen barrier.

The elastic modulus of the multilayer films is measured to evaluate potential usage in thermoforming applications. A specimen of each multilayer film is cut using a 6.0×40.0 mm die in the machine direction. The elastic modulus is measured using a Rheometrics Solid Analyzer (RSA III) from TA Instruments with the following settings:

Temperature Range: 60° C.-120° C.

Ramp Rate: 5° C./minute

Test Frequency: 50 radians/second

Strain Amplitude: 0.05%

The results are shown in Table 5:

TABLE 5

| Temp | Comp. | Comp. | Inv. | Inv. | Inv. | Inv. | Inv. | Inv. |
|---|---|---|---|---|---|---|---|---|
| (° C.) | Ex. A | Ex. B | Ex. 1 | Ex. 2 | Ex. 3 | Ex. 4 | Ex. 5 | Ex. 6 |
| 60 | 94.6 | 164 | 180 | 147 | 148 | 121 | 112 | 170 |
| 65 | 66.3 | 141 | 134 | 123 | 104 | 86.7 | 88.7 | 142 |
| 70 | 56.0 | 125 | 115 | 110 | 90.8 | 78.1 | 75.9 | 123 |
| 75 | 49.6 | 111 | 103 | 98.6 | 84.1 | 72.6 | 67.7 | 107 |
| 80 | 42.3 | 97.3 | 97.5 | 88.3 | 78.6 | 60.5 | 56.2 | 90.7 |
| 85 | 33.4 | 87.6 | 87.9 | 77.2 | 70.8 | 48.9 | 46.6 | 77.1 |
| 90 | 25.6 | 79.4 | 81.6 | 67.3 | 62.3 | 39.5 | 37.5 | 64.7 |
| 95 | 17.9 | 74.5 | 74.4 | 59.1 | 53.1 | 31.2 | 30.5 | 53.4 |
| 100 | 13.1 | 70.1 | 70.4 | 52.4 | 46.1 | 24.7 | 24.3 | 46.3 |
| 105 | 9.34 | 66.4 | 66.0 | 46.3 | 40.5 | 19.9 | 19.6 | 37.9 |
| 110 | 4.00 | 61.5 | 59.1 | 38.2 | 31.4 | 12.6 | 12.4 | 29.1 |
| 115 | | 52.9 | 51.3 | 29.0 | 19.4 | 2.60 | 2.71 | 17.2 |
| 120 | | 45.7 | 42.8 | 7.24 | | | | |

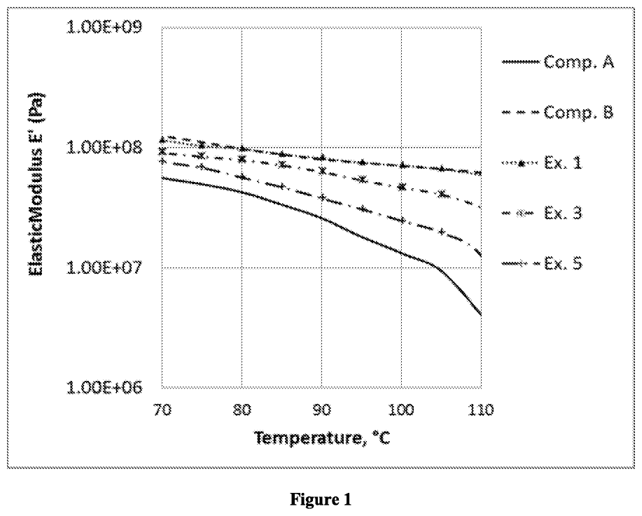

FIG. 1 illustrates some of the above data for Comparative Example A (Comp. A), Comparative Example B (Comp. B), Inventive Example 1 (Ex. 1), Inventive Example 3 (Ex. 3), and Inventive Example 5 (Ex. 5).

In addition, the ratio of elastic modulus at 80° C. to elastic modulus at 100° C. is calculated from this data as the typical range of temperatures for thermoforming is between 80 and 100° C. The results are shown in Table 6:

TABLE 6

| | | Weight | E′(80° C.)/ |
|---|---|---|---|
| | Film Summary | % COC | E′ (100° C.) |
| Inventive Example 1 | 20% COC in Layer C | 4% | 3.1 |
| Inventive Example 2 | 10% COC in Layers B | 4% | 2.3 |
| | and D | | |
| Inventive Example 3 | 10% COC in Layers A | 4% | 2.5 |
| | and E | | |
| Inventive Example 4 | 5% COC in Layers B and D | 2% | 4.8 |
| Inventive Example 5 | 5% COC in Layers A and E | 2% | 4.5 |
| Inventive Example 6 | 20% COC in Layer A | 4% | 3.1 |
| Inventive Example 7 | 10% COC in Layers A | 4% | 1.9 |
| | and E, ULDPE in Layers B | | |
| | and D | | |
| Comparative | All PE (no COC) | 0% | 10.6 |
| Example A | | | |
| Comparative | 20% Polyamide | 0% | 1.6 |
| Example B | | | |

The data in Tables 5 and 6 show an improvement in rheological behavior when COC is incorporated into the multilayer films, as evidenced by the plateauing of elastic modulus at the temperature range tested.

1. A multilayer film comprising:
a first layer comprising polypropylene, polyethylene, or blends thereof;
a second layer comprising polypropylene, polyethylene, or blends thereof; and
a third layer between the first layer and the second layer, the third layer comprising polypropylene, polyethylene, or blends thereof,
wherein at least one of the layers further comprises a cyclic olefin copolymer and wherein the multilayer film comprises at least 1 weight percent and less than 5 weight percent cyclic olefin copolymer based on the total weight of the film.

2. The multilayer film of claim 1, wherein the first layer comprises propylene/α-olefin copolymer, propylene homopolymer, or blends thereof.

3. The multilayer film of claim 1, wherein the second layer comprises propylene/α-olefin copolymer, propylene homopolymer, or blends thereof.

4. The multilayer film of claim 1, wherein the third layer comprises propylene/α-olefin copolymer, propylene homopolymer, or blends thereof.

5. A multilayer film comprising:
a first layer comprising polyethylene;
a second layer comprising polyethylene; and
a third layer between the first layer and the second layer, the third layer comprising polyethylene,
wherein at least one of the layers further comprises a cyclic olefin copolymer and wherein the multilayer film comprises at least 1 weight percent and less than 5 weight percent cyclic olefin copolymer based on the total weight of the film.

6. The multilayer film of claim 1, wherein at least two layers further comprise cyclic olefin copolymer.

7. The multilayer film of claim 1, wherein the first layer comprises 5 to 15 weight percent cyclic olefin copolymer based on the weight of the first layer, and wherein the second layer comprises 5 to 15 weight percent cyclic olefin copolymer based on the weight of the second polymer.

8. The multilayer film of claim 1, wherein the third layer further comprises cyclic olefin copolymer.

9. The multilayer film of claim 1, wherein the film comprises at least 5 layers.

10. The multilayer film of claim 1, wherein the two outermost layers comprise cyclic olefin copolymer.

11. The multilayer film of claim 1, wherein the film exhibits a water vapor transmission rate of 1.10 g·mil/m²/day or less when measured according to ASTM F1249 at a relative humidity of 100% and a temperature of 37.8° C.

12. The multilayer film of claim 1, wherein the film exhibits an oxygen transmission rate of 820 cm³·mil/100 in²/day or less when measured in accordance with ASTM D3985 using a Mocon Oxtran OTR testing system (Model 2/21) at an oxygen content of 100%, a relative humidity of 90%, and a temperature of 23° C.

13. The multilayer film of claim 1, wherein the film exhibits a ratio of elastic modulus at 80° C. to elastic modulus at 100° C. of less than 10.

14. The multilayer film of claim 1, wherein the film is free of polyamide.

15. An article formed from the multilayer film of claim 1.
